(19) United States
(12) Patent Application Publication
(10) Pub. No.: US 2012/0082269 A1
(43) Pub. Date: Apr. 5, 2012

(54) METHOD FOR CHANNEL ESTIMATION AND DELAY SPREAD APPROXIMATION IN A WIRELESS COMMUNICATION SYSTEM

(75) Inventors: Hsiao Lan CHIANG, Miaoli County (TW); Pang An Ting, Taichung County (TW); Jen Yuan Hsu, Kinmen County (TW)

(73) Assignee: INDUSTRIAL TECHNOLOGY RESEARCH INSTITUTE, Chutung (TW)

(21) Appl. No.: 12/977,284

(22) Filed: Dec. 23, 2010

(30) Foreign Application Priority Data
Oct. 5, 2010 (TW) 099133797

(51) Int. Cl. H04L 27/06

(52) U.S. Cl. 375/340

(57) ABSTRACT

A method for delay spread approximation used in a wireless communication system comprises the steps of: retrieving a plurality of pilot symbols from a channel of a wireless communication system; calculating at least one parameter representing the shape of the frequency response of the channel according to the values and the relative positions of the pilot symbols; determining a representative parameter value according to the at least one parameter; and determining a delay spread value according to the representative parameter value.

### 1. TECHNICAL FIELD

The disclosure relates to an estimation method for a channel and its delay spread value of a wireless communication system.

### 2. BACKGROUND

In a wireless communication system, a signal is radiated from an antenna at a transmitting end. The signal is then propagated through the air and then received by an antenna of a receiving end. The signal propagation path from the transmitting end to the receiving end is the channel of the wireless communication system. The channel can alter the amplitude and the phase of the signal, so there can be a difference between the transmitted signal from the transmitting end and the received signal by the receiving end, such difference being caused by the channel. Therefore, in addition to the signal received by the receiving end, the knowledge of the channel distribution of the wireless communication system is also required to obtain the original signal from the transmitting end. Generally, a wireless communication system applies a channel estimation technique to obtain the channel distribution of the wireless communication system.

Several channel estimation techniques exist for current wireless communication systems. For example, a wireless communication system using orthogonal frequency division multiplexing (OFDM) as the modulation scheme uses pilot symbols to perform the channel estimation technique, wherein the pilot symbols, which carry known pilot values to the receiving end, are spread over sub-carriers of different time slots. The most common method of modulation is the minimum mean square error (MMSE) algorithm. In the MMSE algorithm, it is assumed that the power delay profile of the channel is evenly distributed or decays exponentially. Most of the current techniques for estimating the power delay profile of the channel require second-order statistics regardless of the channel model. Accordingly, the system computation is increased significantly.

In addition, as research continues to advance channel estimation methods, many delay spread approximation methods have been provided to estimate the channel's power delay profile. Among these delay spread approximation methods, one method presumes that the delay spread is proportional to the level crossing rate of the channel transfer function. This method requires dense frequency sampling of the channel response to assure an accurate estimation of the level crossing rate. Another method exploits the relationship between the cyclic prefix correlation and the root mean square (RMS) delay spread of the exponential power delay profile. Several methods are based on frequency-domain correlation functions of the channel response or the received signals. However, the required computational complexities for the aforementioned methods are relatively high. In addition, all of the aforementioned methods require nearly complete information of the channel in time or frequency domain, which is difficult to obtain in practical OFDM systems with widely spaced pilot symbols.

Accordingly, there is a need to design an estimation method for a channel and its delay spread value of a wireless communication system, wherein the method can estimate delay spread and therefore the channel of the wireless communication system by observing the channel shape in an easy and fast manner.

### SUMMARY

The estimation method for a channel and its delay spread value of a wireless communication system are disclosed. The method estimates delay spread and therefore the channel of the wireless communication system by exploiting the tendency for the shape profile of the channel frequency response, such as the curvature or the slope of the shape of the channel frequency response, to be proportional to the delay spread of the channel. Therefore, the channel approximation can be estimated according to the channel distribution.

One embodiment discloses a method for channel approximation used in a wireless communication system, comprising the steps of: retrieving a plurality of pilot symbols from a channel of a wireless communication system; calculating at least one parameter representing the shape of the frequency response of the channel according to the values and the relative positions of the pilot symbols; determining a representative parameter value according to the at least one parameter; determining a delay spread value according to the representative parameter value; and estimating the channel according to the delay spread value.

Another embodiment discloses a method for delay spread approximation used in a wireless communication system, comprising the steps of: retrieving a plurality of pilot symbols from a channel of a wireless communication system; calculating at least one parameter representing the shape of the frequency response of the channel according to the values and the relative positions of the pilot symbols; determining a representative parameter value according to the at least one parameter; and determining a delay spread value according to the representative parameter value.

### BRIEF DESCRIPTION OF THE DRAWINGS

The accompanying drawings, which are incorporated in and constitute a part of this specification, illustrate embodiments of the disclosure and, together with the description, serve to explain the principles of the invention.

FIG. 1 shows the pilot symbols in spatial streams of a two-input two-output system;

FIG. 2 shows the pilot symbols in spatial streams of a four-input four-output system;

FIG. 3 is a flowchart illustrating an exemplary embodiment of a method for delay spread approximation used in a wireless communication system;

FIG. 4 shows the values of pilot symbols and the corresponding ideal frequency response of according to an exemplary embodiment;

FIG. 5 is a flowchart illustrating another exemplary embodiment of a method for delay spread approximation used in a wireless communication system;

FIG. 6 is a flowchart illustrating another exemplary embodiment of a method for delay spread approximation used in a wireless communication system;

FIG. 7 shows the values of pilot symbols and the corresponding ideal frequency response of according to another exemplary embodiment;

FIG. 8 is a flowchart illustrating an exemplary embodiment of a method for channel approximation used in a wireless communication system; and

FIG. 9 is a flowchart illustrating another exemplary embodiment of a method for channel approximation used in a wireless communication system.

### DETAILED DESCRIPTION

In a time-varying system, the auto correlation function of the channel transfer function in time domain and frequency domain can be decomposed as: r_{H}(Δt, Δf)=r_{H}(Δt)·r_{H}(Δf). Both r_{H}(Δt) and r_{H}(Δf) can be approximated by a sinc function and can be represented as follows: r_{H}(Δt)=sinc(2πf_{D}Δt) and r_{H} (Δt)=sinc(πτₘΔf)e^{-j2πτ}^{_{shift}}^{Δf}, wherein f_{D} is the maximum Doppler frequency, rₘ is the multiple delay spread of the channel and τ_{shift} denotes the displacement of the multipath intensity profile. Among these parameters, τₘ, i.e. the delay spread, is the parameter to be estimated by the estimation method for a channel and its delay spread value of a wireless communication system of this disclosure, while f_{D} and τ_{shift} are not in the scope of this disclosure.

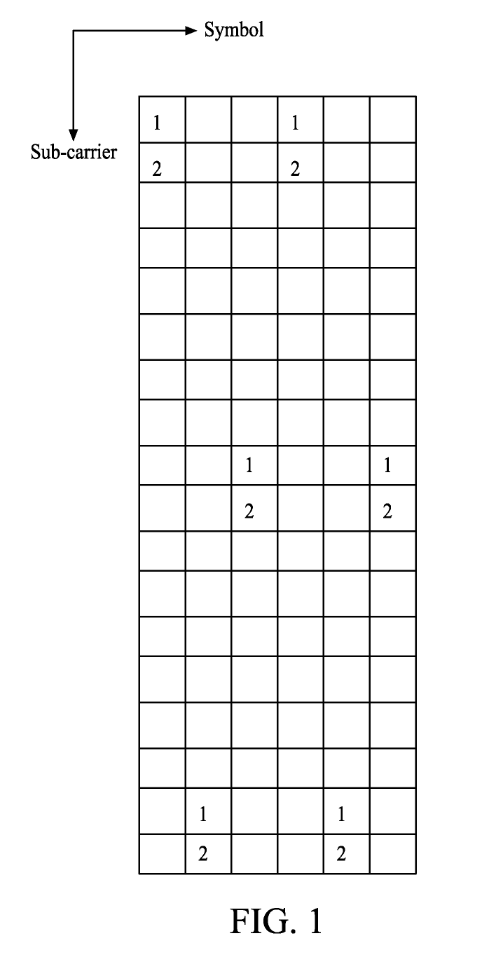

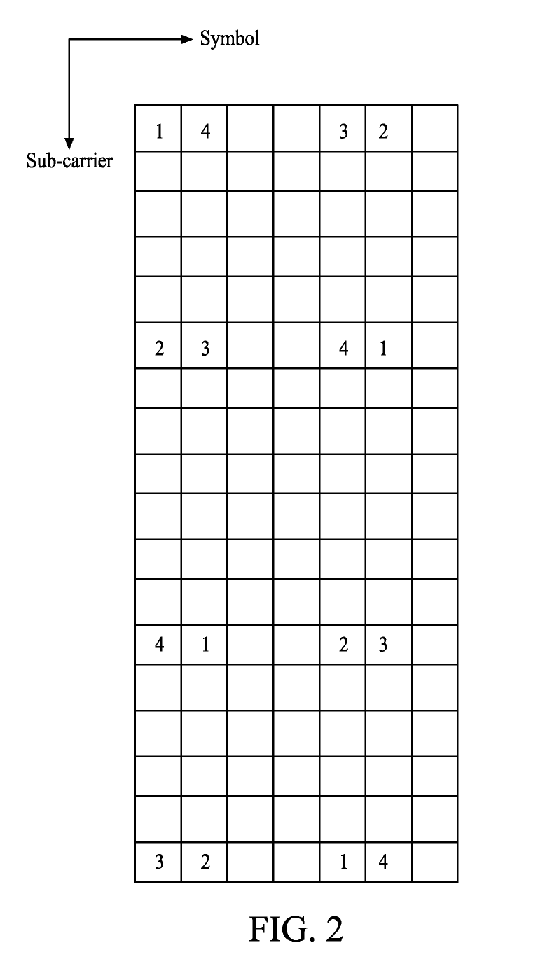

In current OFDM wireless communication systems, such as the wireless communication systems conforming to Institute of Electrical and Electronic Engineers (IEEE) 802.16 standard, the receiving end does not necessarily have all of the symbols carried by the sub-carriers. For example, in some cases, a receiving end is allocated with only one resource unit (RU), which comprises only 18 consecutive sub-carriers, including a few pilot symbols, as shown in FIGS. 1 and 2. Under such circumstances, it is difficult for the receiving end to estimate the channel distribution according to such small number of pilot symbols. Therefore, applying the conventional estimation method for a channel and its delay spread value becomes impractical. Nevertheless, since delay spread is inversely proportional to a channel's coherent bandwidth, this disclosure estimates delay spread by observing the channel's shape profile. Specifically, a representative parameter value, such as a slope or a curvature of the shape of the frequency response of the channel, is used to represent a channel's shape profile for the purpose of channel estimation.

FIG. 1 shows a resource unit comprising two sets of data streams. The resource unit comprises only 18 sub-carriers of symbols. The pilot symbols marked as one in FIG. 1 are allocated to the first data stream. The pilot symbols marked as two in FIG. 1 are allocated to the second data stream. As shown in FIG. 1, these pilot symbols are spread over different sub-carriers based on their time slots.

FIG. 2 shows a resource unit comprising four sets of data streams. Similarly, the resource unit comprises only 18 sub-carriers of symbols. The pilot symbols marked as one in FIG. 2 are allocated to the first data stream. The pilot symbols marked as two in FIG. 2 are allocated to the second data stream. The pilot symbols marked as three in FIG. 2 are allocated to the third data stream. The pilot symbols marked as four in FIG. 2 are allocated to the fourth data stream. As shown in FIG. 2, these pilot symbols are spread over different sub-carriers based on their time slots.

As can be seen from FIG. 1, in a two-input two-output system, if each receiving end is allocated with only one resource unit, after a receiving end receives six symbols, each data stream contains six pilot symbols. Similarly, as can be seen from FIG. 2, in a four-input four-output system, if each receiving end is allocated with only one resource unit, after a receiving end receives six symbols, each data stream contains four pilot symbols. Since each receiving end can only receive partial frequency information, applying the conventional method for a channel and its delay spread value is relatively difficult.

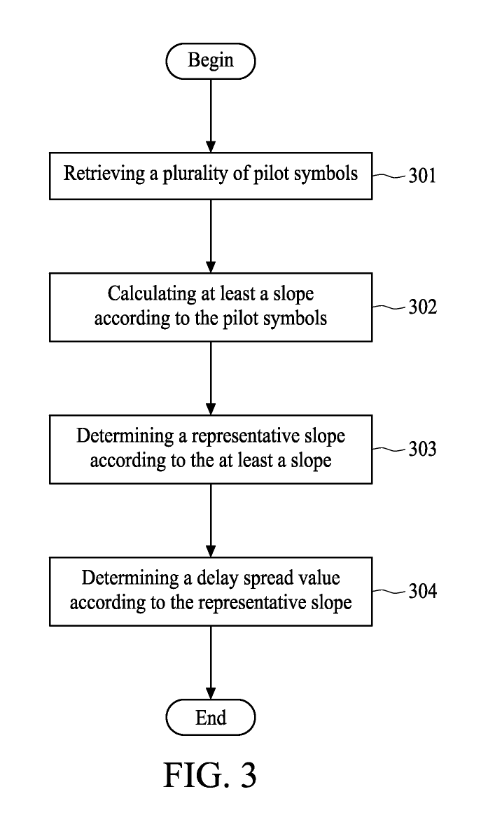

FIG. 3 is a flowchart illustrating an exemplary embodiment of a method for delay spread approximation used in a wireless communication system. In step 301, a plurality of pilot symbols are retrieved from a channel of a wireless communication system, and step 302 is executed. In step 302, at least one slope is calculated according to the values and the relative positions of the pilot symbols, and step 303 is executed. In step 303, a representative slope is determined according to the at least one slope, and step 304 is executed. In step 304, a delay spread value is determined according to the representative slope.

Since the values of each pilot symbol represent the frequency response of the channel at the corresponding sub-carriers, by exploiting the fact that the slope of the shape of the frequency response of the channel is inversely proportional to the coherent bandwidth of the channel, and that the delay spread is inversely proportional to the coherent bandwidth of the channel, it can be determined that the slope of the shape of the frequency response of the channel is proportional to the delay spread. Accordingly, the delay spread approximation can be achieved by calculating the slope of the shape of the frequency response of the channel.

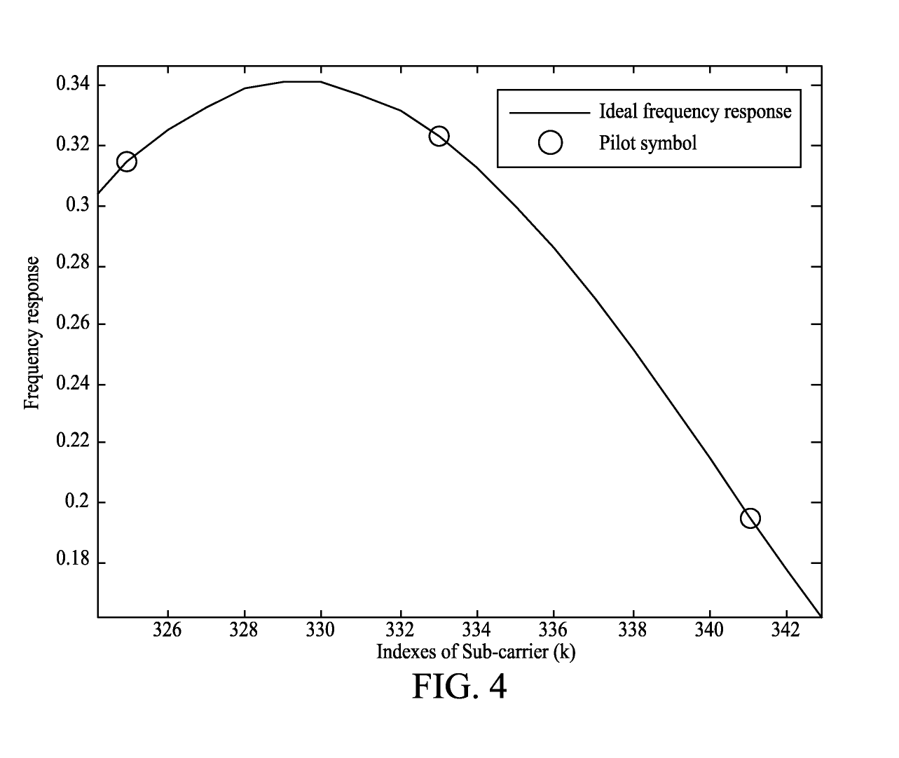

The following illustrates applying the method shown in FIG. 3 to the resource unit shown in FIG. 1. In step 301, a plurality of pilot symbols are retrieved: the value of the first data stream at the first time slot and the first sub-carrier is 0.3145; the value of the first data stream at the second time slot and the 17^{th} sub-carrier is 0.1958; and the value of the first data stream at the third time slot and the 9^{th} sub-carrier is 0.3237. In step 302, at least one slope is calculated according to the values and the relative positions of the pilot symbols. FIG. 4 shows the values of such pilot symbols, i.e. the frequency response of the channel at the sub-carriers corresponding to such pilot symbols. The circles shown in FIG. 4 are the values of such pilot symbols, wherein the curve shown in FIG. 4 is the ideal frequency response of the channel. As shown in FIG. 4, two slopes S1 and S2 can be defined by the three pilot symbols. The absolute values of the two slopes S1 and S2 are 0.00115 and 0.01599, respectively. In step 303, a representative slope is determined according to the at least one slope. Since there may exist a local maximum or local minimum between the two pilot symbols corresponding to the slope with the smaller value, i.e. slope S1, such that the estimation of the delay spread may be less accurate, this exemplary embodiment uses the slope with the greatest value, i.e. slope S2, for the delay spread approximation. Therefore, the slope S2 is determined to be the representative parameter value. In step 304, a delay spread value is determined according to the representative slope. In this exemplary embodiment, to reduce the computational complexity, several slopes and the corresponding delay spread values are stored as a look-up table. Accordingly, the targeted delay spread value corresponding to the slope S2 can be found by referring to the look-up table.

In some exemplary embodiments of this disclosure, by exploiting the fact that the curvature of the shape of the frequency response of the channel is inversely proportional to the coherent bandwidth of the channel, and that the delay spread is inversely proportional to the coherent bandwidth of the channel, it can be determined that the curvature of the shape of the frequency response of the channel is proportional to the delay spread. Accordingly, the delay spread approximation can be achieved by calculating the curvature of the shape of the frequency response of the channel.

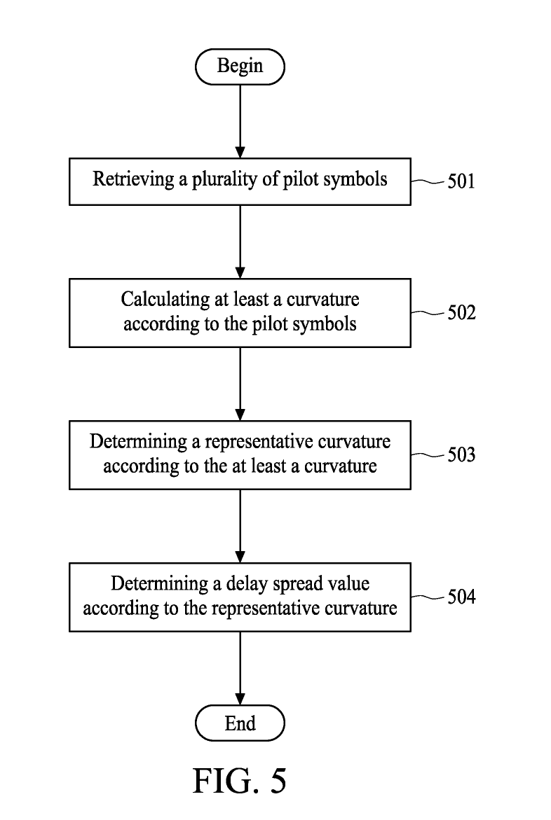

FIG. 5 is a flowchart illustrating another exemplary embodiment of a method for delay spread approximation used in a wireless communication system. In step 501, a plurality of pilot symbols are retrieved from a channel of a wireless communication system, and step 502 is executed. In step 502, at least one curvature is calculated according to the values and the relative positions of the pilot symbols, and step 503 is executed. In step 503, a representative curvature is determined according to the at least one parameter, and step 504 is executed in step 504, a delay spread value is determined according to the representative curvature.

In some exemplary embodiments of this disclosure, it is assumed that zᵢ(s)=[xᵢ(s),yᵢ(s)] is a point on a curvature. Accordingly, a curvature function can

$$\begin{matrix}{\vert \frac{{d}^{2} {z}_{i}}{d {s}^{2}} \vert}^{2} \approx {\vert {z}_{i - 1} - 2 {z}_{i} + {z}_{i + 1} \vert}^{2} \\ = {( {x}_{i - 1} - 2 {x}_{i} + {x}_{i + 1} )}^{2} + {( {y}_{i - 1} - 2 {y}_{i} + {y}_{i + 1} )}^{2}\end{matrix}$$

be used to calculate the curvature value of the channel frequency response, wherein xᵢ is the index of a first pilot symbol, yᵢ is the value of the first pilot symbol, xᵢ₋₁ and xᵢ₊₁ are respectively the indexes of a second pilot symbol and a third pilot symbol adjacent to the first pilot symbol, and yᵢ₋₁, and yᵢ₊₁ are respectively the values of the second pilot symbol and the third pilot symbol.

The following illustrates applying the method shown in FIG. 5 to the resource unit shown in FIG. 1. As shown in FIG. 1, if the intervals between pilot symbols are equal, then the indexes of these pilot symbols cancel out each other. Accordingly, the value inside the first parenthesis of the curvature function is zero. Only the value inside the second parenthesis of the curvature function is required to be calculated. If there are more than two pilot symbols, a plurality of curvature values can be obtained. In some exemplary embodiments of this disclosure, the representative curvature value is the mean of such curvature values.

The aforementioned exemplary embodiments are carried out when the receiving end is still or at a low speed. Under such circumstances, there is little difference in the frequency response at different times. Therefore, pilot symbols from different times can be used for the delay spread approximation without compromising the accuracy of the approximation result. However, when the speed of the receiving end becomes faster, e.g. when the speed of the receiving end exceeds a threshold value, another exemplary embodiment of a method for channel and its delay spread approximation used in a wireless communication system can be applied.

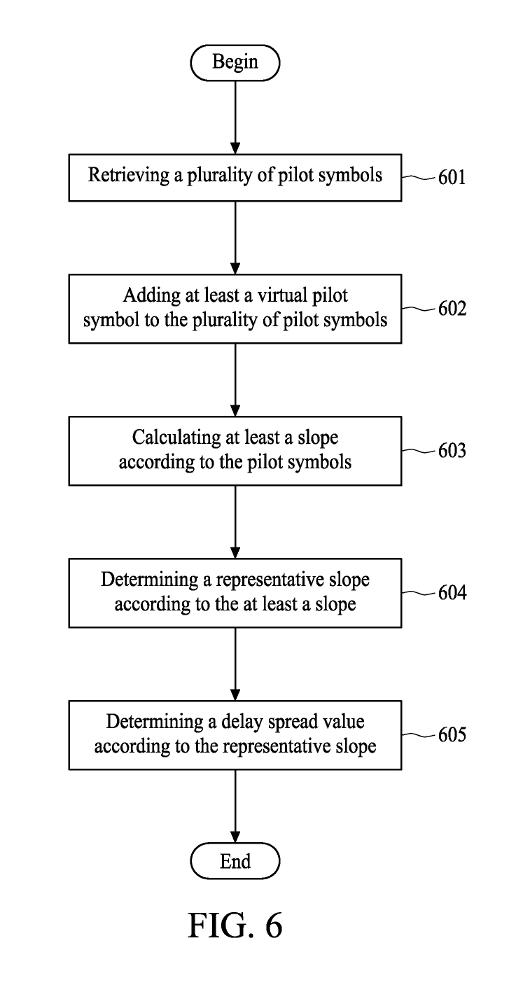

FIG. 6 is a flowchart illustrating another exemplary embodiment of a method for delay spread approximation used in a wireless communication system. In step 601, a plurality of pilot symbols are retrieved from a channel of a wireless communication system, and step 602 is executed. In step 602, at least one virtual pilot symbol is added to the plurality of pilot symbols, and step 603 is executed. In step 603, at least one slope is calculated according to the values and the relative positions of the pilot symbols, and step 604 is executed. In step 604, a representative slope is determined according to the at least one parameter, and step 605 is executed. In step 605, a delay spread value is determined according to the representative slope.

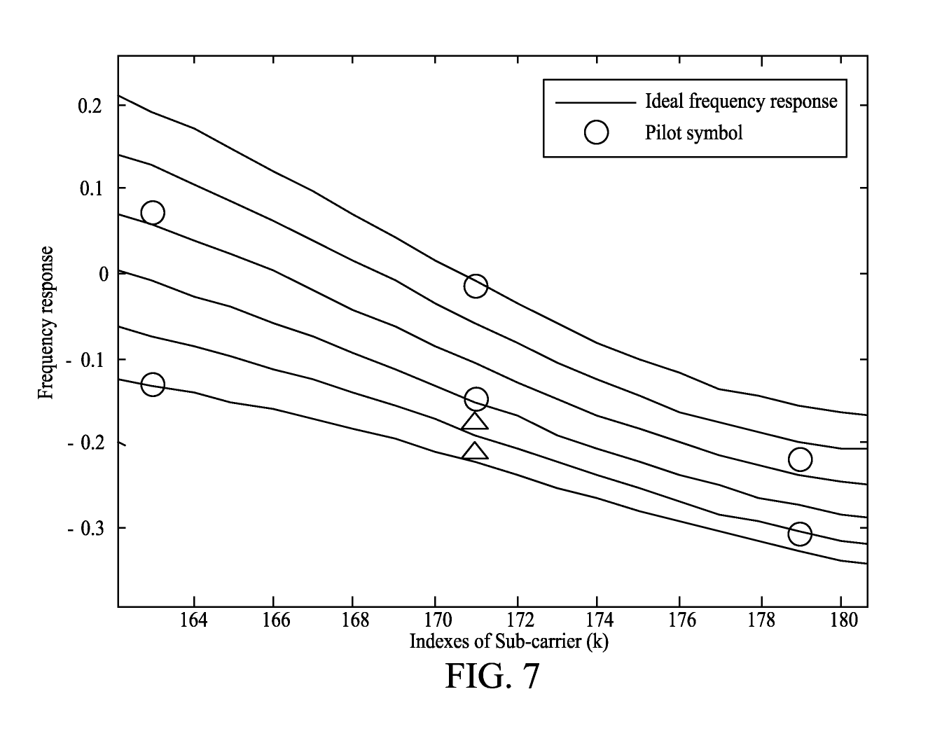

Comparing the methods shown in FIGS. 3 and 6, it can be seen that an additional step of adding at least one virtual pilot symbol to the plurality of pilot symbols is carried out by the method shown in FIG. 6. FIG. 7 shows the values of pilot symbols and the corresponding ideal frequency response thereof according to another exemplary embodiment. The circles shown in FIG. 7 are the values of a plurality of pilot symbols, wherein the curve shown in FIG. 7 is the ideal frequency response of a channel. In this exemplary embodiment, the speed of the receiving end is 120 kilometers per hour. Accordingly, a single index of sub-carrier at different times corresponds to different frequency responses. If the method shown in FIG. 3 is applied, the slope values calculated according to pilot symbols at different times may cause estimation error. If the method shown in FIG. 6 is applied, at least one virtual pilot symbol corresponding to virtual values of the plurality of pilot symbols at the same position but different times can be added, such that a plurality of pilot symbols at the same time can be obtained. As shown in FIG. 7, the triangle marks denote such added virtual pilot symbols.

The step of adding at least one virtual pilot symbol to the plurality of pilot symbols shown in FIG. 6 can also be applied to the method shown in FIG. 5. Accordingly, the method for delay spread approximation used in a wireless communication system provided by this disclosure is still applicable when the speed of the receiving end is high.

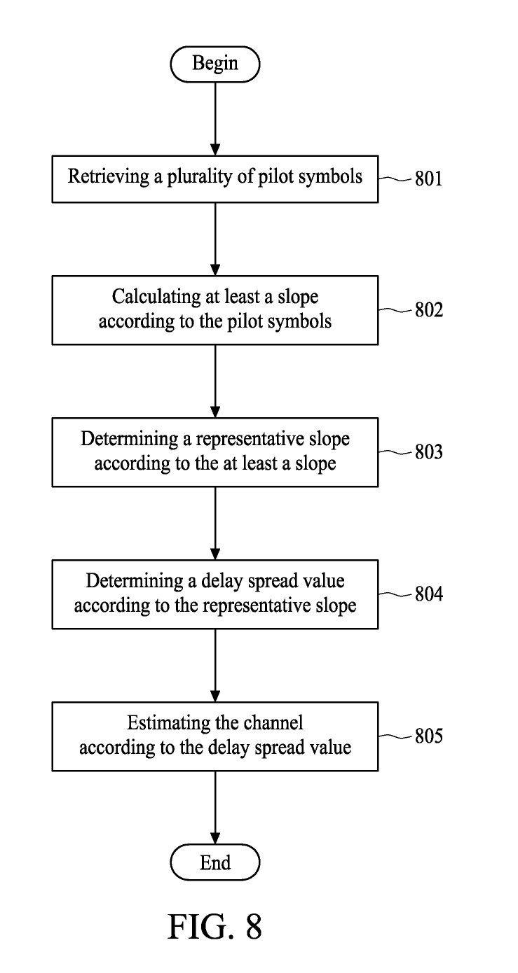

The method for delay spread approximation used in a wireless communication system provided by this disclosure can further be applied to the method for channel approximation. FIG. 8 is a flowchart illustrating an exemplary embodiment of a method for channel approximation used in a wireless communication system. In step 801, a plurality of pilot symbols are retrieved from a channel of a wireless communication system, and step 802 is executed in step 802, at least one slope is calculated according to the values and the relative positions of the pilot symbols, and step 803 is executed. In step 803, a representative slope is determined according to the at least one slope, and step 804 is executed. In step 804, a delay spread value is determined according to the representative slope, and step 805 is executed. In step 805, the channel is estimated according to the delay spread value.

Comparing the methods shown in FIGS. 3 and 8, it can be seen that the channel is estimated according to the estimated delay spread value. As mentioned above, in a time-varying system, the auto correlation function of the channel transfer function in time domain and frequency domain can be decomposed as: r_{H}(Δt, Δf)=r_{H}(Δt)·r_{H}(Δf), wherein the Fourier transform of the function r_{H}(Δf) can be replaced by some other functions according to the channel characteristics. If the Fourier transform of the function r_{H}(Δf) is approximated by a rectangular function, then r_{H}(Δf)=sinc(πτₘΔf)e^{-j2πτ}^{_{shift}}^{Δf}. That is, the autocorrelation function of the frequency part of the estimated channel is evenly distributed and has a coherent bandwidth, and the coherent bandwidth is inversely proportional to the delay spread value. Accordingly, the estimated delay spread value can be substituted into the above function to obtain the channel distribution. However, the Fourier transform of the function r_{H}(Δf) can also be approximated by some exponentially decayed function. That is, the autocorrelation function of the frequency part of the estimated channel is exponentially decayed and has a coherent bandwidth, and the coherent bandwidth is inversely proportional to the delay spread value. Based on the method shown in FIG. 8, the channel distribution can be obtained according to the estimated delay spread value.

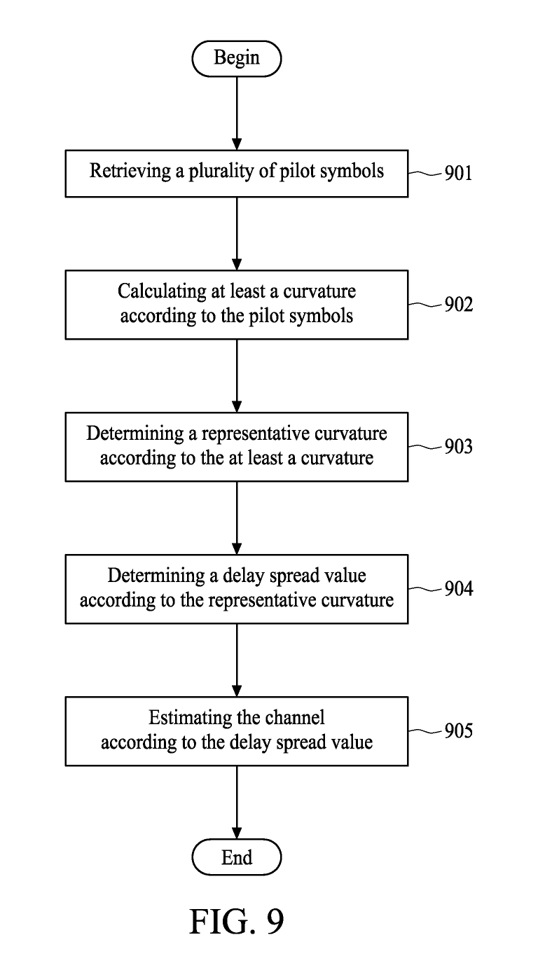

Similarly, the method for delay spread approximation shown in FIG. 5 can further be applied to the method for channel approximation. FIG. 9 is a flowchart illustrating another exemplary embodiment of a method for channel approximation used in a wireless communication system. In step 901, a plurality of pilot symbols are retrieved from a channel of a wireless communication system, and step 902 is executed. In step 902, at least one curvature is calculated according to the values and the relative positions of the pilot symbols, and step 903 is executed. In step 903, a representative curvature is determined according to the at least one parameter, and step 904 is executed. In step 904, a delay spread value is determined according to the representative curvature, and step 905 is executed. In step 905, the channel is estimated according to the delay spread value.

In conclusion, the estimation method for a channel and its delay spread value of a wireless communication system provided by this disclosure exploits the fact that the slope and the curvature of the shape of the frequency response of the channel are inversely proportional to the coherent bandwidth of the channel, and that the delay spread is inversely proportional to the coherent bandwidth of the channel, to determine that the slope and the curvature of the shape of the frequency response of the channel are proportional to the delay spread. Accordingly, by calculating the slope and the curvature of the shape of the frequency response of the channel, the delay spread value of the channel can be obtained. The channel distribution can also be obtained according to the estimated delay spread value.

The above-described exemplary embodiments are intended to be illustrative only. Those skilled in the art may devise numerous alternative embodiments without departing from the scope of the following claims.

What is claimed is:

1. A method for channel approximation used in a wireless communication system, comprising the steps of:
retrieving a plurality of pilot symbols from a channel of a wireless communication system;
calculating at least one parameter representing the shape of the frequency response of the channel according to the values and the relative positions of the pilot symbols;
determining a representative parameter value according to the at least one parameter;
determining a delay spread value according to the representative parameter value; and
estimating the channel according to the delay spread value.

2. The method of claim 1, further comprising a step of:
adding at least one virtual pilot symbol to the plurality of pilot symbols, wherein the at least one virtual pilot symbol corresponds to virtual values of the plurality of pilot symbols in the same position at different times.

3. The method of claim 2, which is performed at a receiving end of the wireless communication system, wherein the adding step is executed when the velocity of the receiving end exceeds a threshold value.

4. The method of claim 1, wherein the plurality of pilot symbols are retrieved by a resource unit.

5. The method of claim 1, wherein the at least one parameter is at least one slope of the shape of the frequency response of the channel, and the representative parameter value is one of the values of the at least one slope of the shape of the frequency response of the channel.

6. The method of claim 5, wherein the representative parameter value is the slope with the maximum value of the at least one slope of the shape of the frequency response of the channel.

7. The method of claim 1, wherein the at least one parameter is at least one curvature of the shape of the frequency response of the channel, and the representative parameter value is one of the values of the at least one curvature of the shape of the frequency response of the channel.

8. The method of claim 1, wherein the at least one curvature of the shape of the frequency response of the channel is determined according to a function:
(xᵢ₋₁2xᵢ+xᵢ₊₁)²+(yᵢ₋₁2yᵢ+yᵢ₊₁)²;
wherein xᵢ is the index of a first pilot symbol, y, is the value of the first pilot symbol, xᵢ₋₁ and xᵢ₊₁ are respectively the indexes of a second pilot symbol and a third pilot symbol adjacent to the first pilot symbol, and yᵢ₋₁ and yᵢ₊₁ are respectively the value of the second pilot symbol and the third pilot symbol.

9. The method of claim 7, wherein the representative parameter value is a mean value of the at least one curvature of the shape of the frequency response of the channel.

10. The method of claim 1, wherein the representative parameter value is mapped to the delay spread value according to a look-up table.

11. The method of claim 1, wherein the autocorrelation function of the frequency part of the estimated channel is evenly distributed and has a coherent bandwidth, and the coherent bandwidth is inversely proportional to the delay spread value.

12. The method of claim 1, wherein the autocorrelation function of the frequency part of the estimated channel exponentially decays and has a coherent bandwidth, and the coherent bandwidth is inversely proportional to the delay spread value.

13. The method of claim 1, which is applied to a wireless communication system according to the Institute of Electrical and Electronic Engineers (IEEE) 802.16 standard.

14. A method for delay spread approximation used in a wireless communication system, comprising the steps of:
retrieving a plurality of pilot symbols from a channel of a wireless communication system;
calculating at least one parameter representing the shape of the frequency response of the channel according to the values and the relative positions of the pilot symbols;
determining a representative parameter value according to the at least one parameter; and
determining a delay spread value according to the representative parameter value.

15. The method of claim 14, further comprising a step of:
adding at least one virtual pilot symbol to the plurality of pilot symbols, wherein the at least one virtual pilot symbol corresponds to virtual values of the plurality of pilot symbols in the same position at different times.

16. The method of claim 15, which is performed at a receiving end of the wireless communication system, wherein the adding step is executed when the velocity of the receiving end exceeds a threshold value.

17. The method of claim 14, wherein the plurality of pilot symbols are retrieved by a resource unit.

18. The method of claim 14, wherein the at least one parameter is at least one slope of the shape of the frequency response of the channel, and the representative parameter value is one of the values of the at least one slope of the shape of the frequency response of the channel.

19. The method of claim 18, wherein the representative parameter value is the slope with the maximum value of the at least one slope of the shape of the frequency response of the channel.

20. The method of claim 14, wherein the at least one parameter is at least one curvature of the shape of the frequency response of the channel, and the representative parameter value is one of the values of the at least one curvature of the shape of the frequency response of the channel.

21. The method of claim 20, wherein the at least one curvature of the shape of the frequency response of the channel is determined according to a function:
(xᵢ₋₁−2xᵢxᵢ₊₁)²+(yᵢ₋₁−2yᵢyᵢ₊₁)²;
wherein xᵢ is the index of a first pilot symbol, yᵢ is the value of the first pilot symbol, xᵢ₋₁ and xᵢ₊₁ are respectively the indexes of a second pilot symbol and a third pilot symbol adjacent to the first pilot symbol, and yᵢ₋₁ and yᵢ₊₁ are respectively the value of the second pilot symbol and the third pilot symbol.

22. The method of claim 20, wherein the representative parameter value is a mean value of the at least one curvature of the shape of the frequency response of the channel.

23. The method of claim 14, wherein the representative parameter value is mapped to the delay spread value according to a look-up table.

24. The method of claim 14, which is applied to a wireless communication system according to the Institute of Electrical and Electronic Engineers (IEEE) 802.16 standard.
